(19) United States
(12) Patent Application Publication
(10) Pub. No.: US 2019/0129980 A1
(43) Pub. Date: May 2, 2019

(54) NESTED CONTROLLERS FOR MIGRATING TRAFFIC BETWEEN ENVIRONMENTS

(71) Applicant: Microsoft Technology Licensing, LLC, Redmond, WA (US)

(72) Inventors: SungJu Cho, Cupertino, CA (US); Ying Lu, Sunnyvale, CA (US); Tianqiang Li, Fremont, CA (US); Yejuan Long, Union City, CA (US); Andrew J. Carter, Mountain View, CA (US)

(73) Assignee: Microsoft Technology Licensing, LLC, Redmond, WA (US)

(21) Appl. No.: 15/797,948

(22) Filed: Oct. 30, 2017

(51) Int. Cl. G06F 17/30

(52) U.S. Cl. CPC G06F 17/30283; G06F 17/30958; G06F 17/303; G06F 17/30864

(57) ABSTRACT

The disclosed embodiments provide a system for migrating traffic between versions of a distributed service. During operation, the system executes a set of nested controllers for migrating traffic from a first version of a distributed service to a second version of the distributed service. Next, the system uses a set of rules to select, by the set of nested controllers, a first deployment environment for processing a query of the distributed service. The system then transmits the query to the first deployment environment.

### BACKGROUND

### Field

The disclosed embodiments relate to migrating traffic between computing or deployment environments. More specifically, the disclosed embodiments relate to nested controllers for migrating traffic between environments.

### Related Art

Data centers and cloud computing systems are commonly used to run applications, provide services, and/or store data for organizations or users. Within the cloud computing systems, software providers may deploy, execute, and manage applications and services using shared infrastructure resources such as servers, networking equipment, virtualization software, environmental controls, power, and/or data center space.

When applications and services are moved, tested, and upgraded within or across data centers and/or cloud computing systems, traffic to the applications and/or services may also require migration. For example, an old version of a service may be replaced with a new version of the service by gradually shifting queries of the service from the old version to the new version. However, traffic migration is commonly associated with risks related to loading, availability, latency, performance, and/or correctness of the applications, services, and/or environments. As a result, outages and/or issues experienced during migration of applications, services, and/or traffic may be minimized by actively monitoring and managing such risks.

### BRIEF DESCRIPTION OF THE FIGURES

FIG. 1 shows a schematic of a system in accordance with the disclosed embodiments.

FIG. 2 shows a graph in a graph database in accordance with the disclosed embodiments.

FIG. 3 shows a system for migrating traffic between services in accordance with the disclosed embodiments.

FIG. 4 shows a flowchart illustrating a process of migrating traffic from a first distributed service to a second distributed service in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

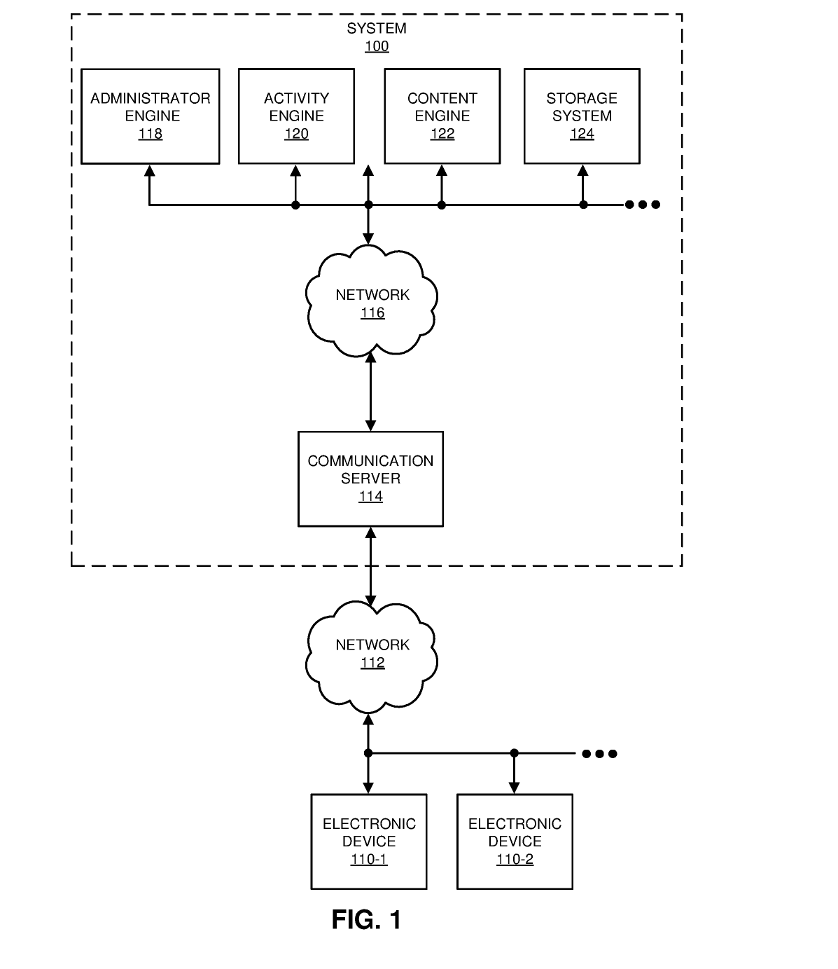

The disclosed embodiments provide a method, apparatus, and system for migrating traffic between environments for providing distributed services. As shown in FIG. 1, a system 100 may provide a service such as a distributed graph database. In this system, users of electronic devices 110 may use the service that is, at least in part, provided using one or more software products or applications executing in system 100. As described further below, the applications may be executed by engines in system 100.

Moreover, the service may, at least in part, be provided using instances of a software application that is resident on and that executes on electronic devices 110. In some implementations, the users interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

A wide variety of services may be provided using system 100. In the discussion that follows, a social network (and, more generally, a network of users), such as an online professional network, which facilitates interactions among the users, is used as an illustrative example. Moreover, using one of electronic devices 110 (such as electronic device 110-1) as an illustrative example, a user of an electronic device may use the software application and one or more of the applications executed by engines in system 100 to interact with other users in the social network. For example, administrator engine 118 may handle user accounts and user profiles, activity engine 120 may track and aggregate user behaviors over time in the social network, content engine 122 may receive user-provided content (audio, video, text, graphics, multimedia content, verbal, written, and/or recorded information) and may provide documents (such as presentations, spreadsheets, word-processing documents, web pages, etc.) to users, and storage system 124 may maintain data structures in a computer-readable memory that may encompass multiple devices (e.g., a large-scale distributed storage system).

Note that each of the users of the social network may have an associated user profile that includes personal and professional characteristics and experiences, which are sometimes collectively referred to as ‘attributes’ or ‘characteristics.’ For example, a user profile may include demographic information (such as age and gender), geographic location, work industry for a current employer, an employment start date, an optional employment end date, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections. However, as described further below, the nodes in the graph stored in the graph database may correspond to additional or different information than the members of the social network (such as users, companies, etc.). For example, the nodes may correspond to attributes, properties or characteristics of the users.

It may be difficult for the applications to store and retrieve data in existing databases in storage system 124 because the applications may not have access to the relational model associated with a particular relational database (which is sometimes referred to as an ‘object-relational impedance mismatch’). Moreover, if the applications treat a relational database or key-value store as a hierarchy of objects in memory with associated pointers, queries executed against the existing databases may not be performed in an optimal manner. For example, when an application requests data associated with a complicated relationship (which may involve two or more edges, and which is sometimes referred to as a ‘compound relationship’), a set of queries may be performed and then the results may be linked or joined. To illustrate this problem, rendering a web page for a blog may involve a first query for the three-most-recent blog posts, a second query for any associated comments, and a third query for information regarding the authors of the comments. Because the set of queries may be suboptimal, obtaining the results may be time-consuming. This degraded performance may, in turn, degrade the user experience when using the applications and/or the social network.

To address these problems, storage system 124 may include a graph database that stores a graph (e.g., as part of an information-storage-and-retrieval system or engine). Note that the graph may allow an arbitrarily accurate data model to be obtained for data that involves fast joining (such as for a complicated relationship with skew or large ‘fan-out’ in storage system 124), which approximates the speed of a pointer to a memory location (and thus may be well suited to the approach used by applications).

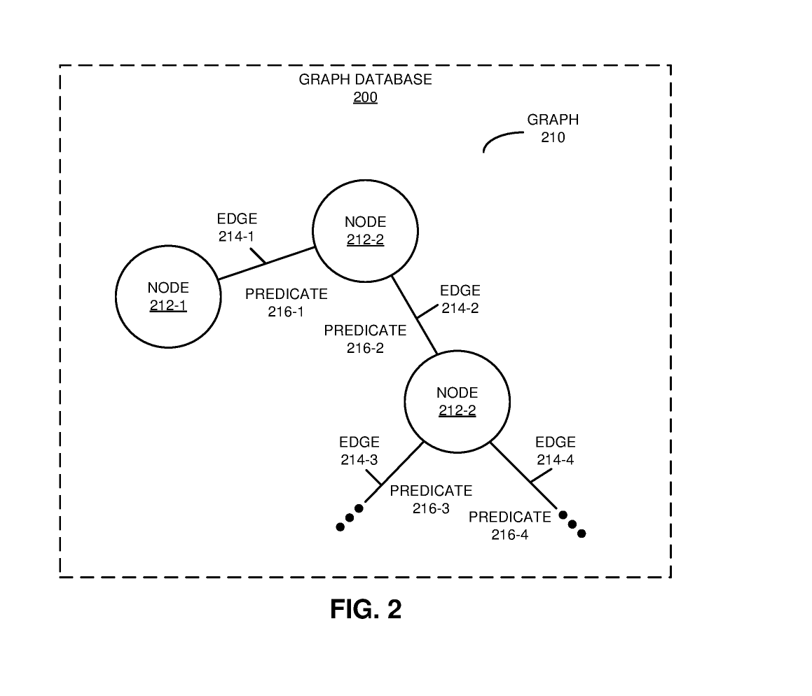

FIG. 2 presents a block diagram illustrating a graph 210 stored in a graph database 200 in system 100 (FIG. 1). Graph 210 includes nodes 212, edges 214 between nodes 212, and predicates 216 (which are primary keys that specify or label edges 214) to represent and store the data with index-free adjacency, so that each node 212 in graph 210 includes a direct edge to its adjacent nodes without using an index lookup.

Note that graph database 200 may be an implementation of a relational model with constant-time navigation (i.e., independent of the size N), as opposed to varying as log(N). Moreover, all the relationships in graph database 200 may be first class (i.e., equal). In contrast, in a relational database, rows in a table may be first class, but a relationship that involves joining tables may be second class. Furthermore, a schema change in graph database 200 (such as the equivalent to adding or deleting a column in a relational database) may be performed with constant time (in a relational database, changing the schema can be problematic because it is often embedded in associated applications). Additionally, for graph database 200, the result of a query may be a subset of graph 210 that maintains the structure (i.e., nodes, edges) of the subset of graph 210.

The graph-storage technique includes embodiments of methods that allow the data associated with the applications and/or the social network to be efficiently stored and retrieved from graph database 200. Such methods are described in U.S. Pat. No. 9,535,963 (issued 3 Jan. 2017), by inventors Srinath Shankar, Rob Stephenson, Andrew Carter, Maverick Lee and Scott Meyer, entitled “Graph-Based Queries,” which is incorporated herein by reference.

Referring back to FIG. 1, the graph-storage techniques described herein may allow system 100 to efficiently and quickly (e.g., optimally) store and retrieve data associated with the applications and the social network without requiring the applications to have knowledge of a relational model implemented in graph database 200. Consequently, the graph-storage techniques may improve the availability and the performance or functioning of the applications, the social network and system 100, which may reduce user frustration and which may improve the user experience. Therefore, the graph-storage techniques may increase engagement with or use of the social network, and thus may increase the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

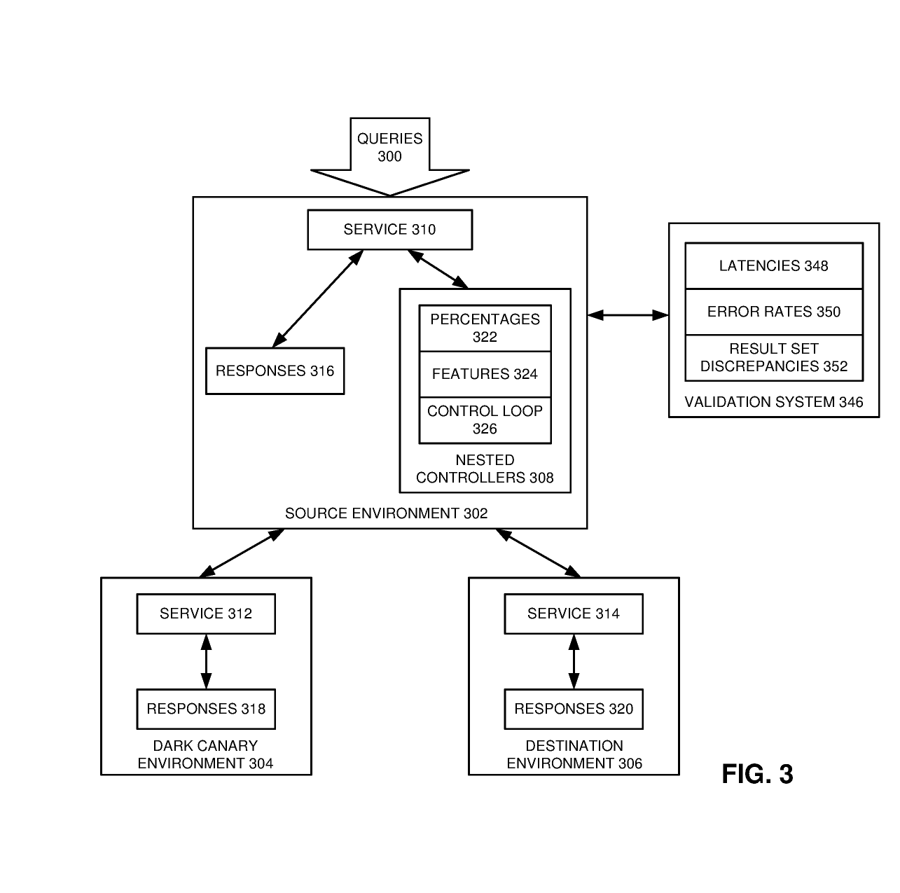

In one or more embodiments, changes to the physical location, feature set, and/or architecture of graph database 200 are managed by controlling the migration of traffic between different versions, instances, and/or physical locations of graph database 200. As shown in FIG. 3, a graph database and/or one or more other services 310-314 (e.g., different versions of the same service and/or different services with the same application-programming interface (API)) are deployed in a source environment 302, a dark canary environment 304, and/or a destination environment 306.

Source environment 302 receives and/or processes queries 300 of services 310-314. Within source environment 302, instances and/or components in service 310 may execute to scale with the volume of queries 300 and/or provide specialized services related to the processing of the queries. For example, one or more instances and/or components of service 310 may provide an API that allows applications, services, and/or other components to retrieve social network data stored in a graph database.

One or more other instances and/or components of service 310 may provide a caching service that caches second-degree networks of social network members represented by nodes in the graph. The caching service may also provide specialized services related to identifying a member's second-degree network, calculating the size of the member's second-degree network, using cached network data to find paths between pairs of members in the social network, and/or using cached network data to calculate the number of hops between the pairs of members. In turn, instances of the caching service may be used by instances of the API to expedite processing of certain types of graph database queries.

One or more additional instances and/or components of service 310 may provide storage nodes that store nodes, edges, predicates, and/or other graph data in multiple partitions and/or clusters. In response to queries 300 and/or portions of queries 300 received from the API, the storage nodes may perform read and/or write operations on the graph data and return results associated with queries 300 to the API for subsequent processing and/or inclusion in responses 316 to queries 300.

As a result, source environment 302 may be a production environment for a stable release of service 310 that receives, processes, and responds to live traffic containing queries 300 from other applications, services, and/or components. In turn, source environment 302 may be used to control the migration and/or replication of traffic associated with queries 300 to one or more services 312-314 in dark canary environment 304 and/or destination environment 306. For example, source environment 302 may be used to migrate and/or replicate queries 300 from service 310 to one or more newer services (e.g., services 312-314) during testing or validation of the newer service(s) and/or a transition from service 310 to the newer service(s).

In one or more embodiments, the system of FIG. 3 includes functionality to perform monitoring and management of traffic migration from source environment 302 to destination environment 306, as well as fine-grained testing, debugging, and/or validation of various services 310-314 and/or service versions using dark canary environment 304. In particular, source environment 302 includes a set of nested controllers 308 that selectively replicate and/or migrate queries 300 across source environment 302, dark canary environment 304, and/or destination environment 306 to test and validate services 312-314 and/or perform migration of traffic from service 310 to service 314.

In some embodiments, dark canary environment 304 is used to test and/or validate the performance of service 312 using live production queries 300 (instead of simulated traffic) without transmitting responses 318 by service 312 to clients from which queries 300 were received. As a result, nested controllers 308 may be configured to replicate some or all queries 300 received by service 310 in source environment 302 to service 312 in dark canary environment 304.

Responses 318 to queries 300 from service 312 may be received by nested controllers 308 and/or other components in source environment 302 and analyzed by a validation system 346 within and/or associated with source environment 302 to assess the performance of service 312. Transmission of responses 318 to the clients may also be omitted to allow service 312 to be tested and/or debugged without impacting the production performance associated with processing queries 300. Instead, queries 300 replicated from source environment 302 to dark canary environment 304 may still be processed by service 310, and responses 316 to queries 300 from service 310 may be transmitted to the clients.

To further facilitate testing, debugging, and/or validation of different services 310-314 and/or service versions, the system may include multiple versions of dark canary environment 304, with each version of dark canary environment 304 containing a different service or service version. For example, one version of dark canary environment 304 may include a stable version of service 312, and another version of dark canary environment 304 may include the latest version of service 312. In turn, responses 318 to queries 300 from each version of service 312 may be compared by validation system 346 to identify degradation and/or other issues with the latest version.

Validation system 346 receives pairs of responses 316-318 to the same queries 300 from services 310-312 and use responses 316-318 to generate metrics and/or other data related to the relative performances of services 310-312. The data may include latencies 348, error rates 350, and/or result set discrepancies 352 associated with processing queries 300 and/or generating responses 316-318. Latencies 348 may include a latency of each query sent to services 310-312, as well as summary statistics associated with aggregated latencies on services 310-312 (e.g., mean, median, 90^{th} percentile, 99^{th} percentile, etc.).

Error rates 350 may include metrics that capture when one or both services 310-312 generate errors in responses 316-318 (e.g., based on a comparison of each pair of responses 316-318 for a given query and/or external validation of one or both responses 316-318). Like latencies 348, error rates 350 may also include aggregated metrics, such as summary statistics for errors over fixed and/or variable intervals.

Result set discrepancies 352 may provide additional information related to errors and/or error rates 350 associated with services 310-312. For example, result set discrepancies 352 may be generated by applying set comparisons and set relationship classifications to one or more pairs of responses 316-318 to the same queries and/or one or more portions of each response (e.g., one or more key-value pairs and/or other subsets of data) in each pair. In turn, result set discrepancies 352 may specify if the compared responses and/or portions are identical (e.g., if a pair of responses return the exact same results), are supersets or subsets of one another (e.g., if all of one response is included in another), partially intersect (e.g., if the responses partially overlap but each response includes elements that are not found in the other element) and/or are completely disjoint (e.g., if the responses contain completely dissimilar data). For data sets that are not identical, result set discrepancies 352 may identify differences between the two sets of data (e.g., data that is in one response but not in the other). Result set discrepancies 352 may further include metrics related to differences between sets of data from services 310-312, such as the number or frequency of non-identical and/or disjoint pairs of responses 316-318 between services 310-312.

Latencies 348, error rates 350, result set discrepancies 352, and/or other data generated or tracked by validation system 346 may be displayed and/or outputted in a reporting platform and/or mechanism. For example, validation system 346 and/or another component of the system may include a graphical user interface (GUI) containing a dashboard of metrics (e.g., queries per second (QPS), average or median latencies 348, error rates 350, frequencies and/or numbers associated with result set discrepancies 352, etc.) generated by validation system 346. The dashboard may also, or instead, include visualizations such as plots of the metrics and/or changes to the metrics over time. As a result, the dashboard may allow administrators and/or other users of the system to monitor and/or compare the per-query performance of services 310-312 and/or pairs of responses 316-318 to the same queries 300 from services 310-312.

The dashboard may additionally be used to configure and/or output alerts related to changes in the metrics and/or summary statistics associated with the metrics (e.g., alerting when a latency, error, or error rate from one or both services 310-312 exceeds a threshold and/or after a certain number of queries 300 have a latency, error, or error rate that exceeds the threshold). The alerts may be transmitted to engineers and/or administrators involved in migrating traffic and/or services 310-314 to allow the engineers and/or administrators to respond to degradation in one or more services 310-312 and/or environments.

In another example, the component may display, export, and/or otherwise output a performance report for services 310-312 on a per-feature basis. The report may be generated by aggregating metrics and/or responses 316-318 on a per-feature basis (e.g., using parameters and/or query names from the corresponding queries 300) and/or generating visualizations based on the aggregated data. The performance report may thus allow the engineers and/or administrators to identify features that may be bottlenecks in performance and/or root causes of degradation or anomalies and take action (e.g., additional testing, development, and/or debugging) to remedy the bottlenecks, degradation, and/or anomalies.

Metrics and/or other data from validation system 346 and/or reporting platform may then be used to evaluate and/or improve the performance and/or correctness of service 312. For example, dark canary environment 304 and validation system 346 may be used by engineers to selectively test and debug new code and/or individual features in the new code before the code is ready to handle production traffic and/or support other features. As a given version of the code (e.g., service 312) is validated, additional modifications may be made to implement additional features and/or functionality in the code until the code is ready to be deployed in a production environment.

After the performance and/or correctness of service 312 is validated using validation system 346, service 312 is deployed as service 314 in destination environment 306. In one or more embodiments, destination environment 306 represents a production environment for service 314, and service 314 may be a newer version of service 310 and/or a different service that will eventually replace service 310 when migration of traffic from source environment 302 to destination environment 306 is complete. Because destination environment 306 is configured to process queries 300 and return responses 320 to queries 300 to the clients in a production setting, nested controllers 308 may be configured to gradually migrate traffic from source environment 302 to destination environment 306 instead of replicating traffic from source environment 302 to destination environment 306. Nested controllers 308 may optionally replicate a portion of the traffic to destination environment 306 across other environments and/or services (e.g., services 310-314) to enable subsequent comparison and/or validation of responses 320 from service 314 by validation system 346 and/or the reporting platform.

As shown in FIG. 3, nested controllers 308 may migrate and/or redirect queries 300 among source environment 302, dark canary environment 304, and/or destination environment 306 based on rules associated with one or more percentages 322, features 324, and/or a control loop 326. Percentages 322 may include a percentage of traffic to migrate from service 310 to service 314 and/or a percentage of traffic to replicate between service 310 and/or one or more other services 312-314. Percentages 322 may be set to accommodate throughput limitations of dark canary environment 304 and/or destination environment 306. Percentages 322 may also, or instead, be set to enable gradual ramping up of traffic to destination environment 306 from source environment 302. For example, percentages 322 may be set or updated to reflect a ramping schedule for gradually migrating traffic from service 310 to service 314 from 10% of features supported by service 314 to 100% of features supported by service 314.

Features 324 may include features of one or more services 310-314. As a result, one or more rules in nested controllers 308 may be used to direct queries 300 to specific services 310-314 based on the availability or lack of availability of the features 324 in services 310-314. For example, nested controllers 308 may match a feature requested in a query to a rule for the feature. If the feature is not supported in service 312 or 314, the rule may specify directing of the query to source environment 302 for processing by service 310. In other words, rules associated with features 324 may be used to enable testing, validation, deployment, and/or use of newer services 312-314 without requiring one or both services 312-314 to implement the full feature set of an older service 310.

Control loop 326 may be used to automate the migration of traffic and/or queries 300 from source environment 302 to destination environment 306 based on one or more parameters in control loop 326. For example, control loop 326 may be a proportional-integral-derivative (PID) controller with the following exemplary representation:

$$u ( t ) = {K}_{p} e ( t ) + {K}_{i} {\int }_{0}^{t} e ( τ ) d τ + {K}_{d} \frac{de ( t )}{dt}$$

In the above representation, u(t) may represent the amount of traffic to direct to service 314, e(t) may represent an error rate of service 314, ∫₀^{t}e(τ)dτ may represent the cumulative sum of the error rate over time, and

$$\frac{de ( t )}{dt}$$

may represent the rate of change of the error rate. Kₚ, Kᵢ, and K_{d} may be tuning constants for the corresponding error terms. In turn, control loop 326 may reduce traffic to service 314 when the error and/or error rate increase.

Rules for applying percentages 322, features 324, and/or control loop 326 to migration and/or replication of traffic among services 310-314 may additionally include dependencies on one another and/or mechanisms for overriding one another. For example, control loop 326 may be used to automate and/or regulate traffic migration to service 314, while features 324 may be used to redirect one or more queries 300 bound for service 314 to service 310 (e.g., when service 314 does not support features requested in the queries). In another example, percentages 322 may be manually set by an administrator to respond to a failure in one or more environments. In turn, the manually set percentages may override the operation of control loop 326 and/or rules that direct queries 300 to different services 310-314 based on features 324 supported by services 310-314. In a third example, nested controllers 308 may select a subset of queries 300 to direct to service 314 according to a rule that specifies a percentage of traffic to direct to service 314. When a query that is destined for service 314 includes one or more features 324 that are not supported by service 314, nested controllers 308 may apply one or more rules to redirect the query to service 310. Nested controllers 308 may also monitor the QPS received by services 310 and 314 and increase the percentage of subsequent queries initially assigned to service 314 to accommodate the anticipated redirecting of some of the queries back to service 310 based on features 324.

By using nested controllers 308 to replicate and migrate traffic among source environment 302, dark canary environment 304, and destination environment 306, the system of FIG. 3 may enable flexible, configurable, and/or dynamic testing, debugging, validation, and/or deployment of one or more related services 310-314, service versions, and/or features in services 310-314. In turn, the system may mitigate and/or avert risks associated with loading, availability, latency, performance, and/or correctness during migration of live traffic from service 310 to service 314. Consequently, the system of FIG. 3 may improve the performance and efficacy of technologies for deploying, running, testing, validating, debugging, and/or migrating distributed services and/or applications and/or the use of the services and/or applications by other clients or users.

Those skilled in the art will appreciate that the system of FIG. 3 may be implemented in a variety of ways. As mentioned above, multiple instances of one or more services 310-314 and/or components in services 310-314 may be used to process queries 300 and/or provide additional functionality related to queries 300. Along the same lines, services 310-314 may execute using a single physical machine, multiple computer systems, one or more virtual machines, a grid, a number of clusters, one or more databases, one or more filesystems, and/or a cloud computing system. For example, source environment 302, dark canary environment 304, and/or destination environment 306 may be provided by separate virtual machines, servers, clusters, data centers, and/or other collections of hardware and/or software resources. In another example, one or more components of services 310-314, validation system 346, and/or nested controllers 308 may be implemented together and/or separately by one or more software components and/or layers.

Moreover, nested controllers 308 may be configured to migrate, replicate, and/or redirect queries 300 among services 310-314 in a number of ways. For example, nested controllers 308 may be configured to direct traffic to different services 310-314 based on query size, response size, query type, query and/or response keys, partitions, and/or other attributes. Such controlled traffic migration may be performed in conjunction with and/or independently of traffic migration that is based on percentages 322, features 324, and/or control loop 326.

Finally, the operation of the system may be configured and/or tuned using a set of configurable rules. For example, the configurable rules may be specified using database records, property lists, Extensible Markup language (XML) documents, JavaScript Object Notation (JSON) objects, and/or other types of structured data. The rules may describe the operation of nested controllers 308, validation system 346, and/or other components of the system. In turn, the rules may be modified to dynamically reconfigure the operation of the system without requiring components of the system to be restarted.

Those skilled in the art will also appreciate that the system of FIG. 3 may be used with various types of services 310-314. For example, operations related to the replication, migration, and/or validation of traffic may be used with multiple types of services 310-314 that process queries 300 and generate response 316-320 to queries 300.

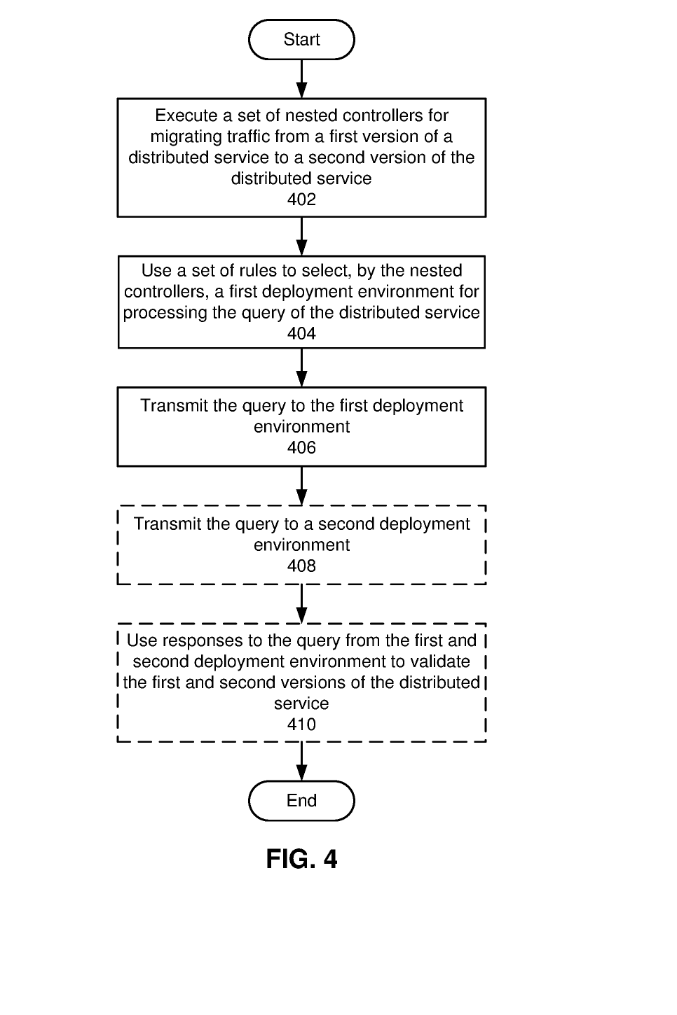

FIG. 4 shows a flowchart illustrating a process of migrating traffic from a first distributed service to a second distributed service in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of nested controllers for migrating traffic from a first version of a distributed service to a second version of the distributed service is executed (operation 402). The nested controllers may execute within one or more instances and/or components of the first version and/or an environment (e.g., source environment) in which the first version is deployed. The first version may be an older and/or stable version of the distributed service, and the second version may be a newer and/or less stable version of the distributed service. For example, the nested controllers may be used to manage and/or control testing, debugging, validation, and/or traffic migration associated with transitioning from an older version of a graph database to a newer version of the graph database.

Next, a set of rules is used to select, by the nested controllers, a first deployment environment for processing the query of the distributed service (operation 404). For example, the first deployment environment may include the first and/or second versions of the distributed service. The rules may include a deployment environment for supporting a feature of the query, a percentage of traffic to migrate between the first distributed service to the second distributed service, and/or a control loop. The control loop may include terms for an error, error duration, and/or error rate that are used to update subsequent migration and/or replication of the traffic between the first and second versions.

The rules may additionally include dependencies and/or overrides associated with one another. For example, the output of one or more rules may be used as input to one or more additional rules that are used to select the first deployment environment for processing the query. In another example, one or more rules may take precedence over one or more other rules in selecting the deployment environment for processing the query.

The query is then transmitted to a first deployment environment (operation 406) and optionally to a second deployment environment (operation 408) for processing the query. For example, the first deployment environment may be a production environment for either version of the service that is used to generate a result of the query and return the result in a response to the query, while the second deployment environment may be a dark canary environment that is optionally used to generate a different result (e.g., using a different version of the distributed service) of the query without transmitting the result to the entity from which the query was received. In another example, the first and second deployment environments may include production environments for the first and second versions of the service. In turn, one environment may be used to transmit a first result of the query to the entity from which the query was received, and another environment may be used to generate a second result that is used to validate the first result and/or monitor the execution or performance of one or both versions of the service.

When the query is transmitted to both deployment environments, responses to the query from both deployment environments are used to validate the first and second versions of the distributed service (operation 410). For example, the responses may be compared to determine latencies, errors, error rates, and/or result set discrepancies associated with the responses. The validation data may be used to modify subsequent directing and/or replicating of queries across deployment environments and/or select service versions and/or features to use or include in the deployment environments.

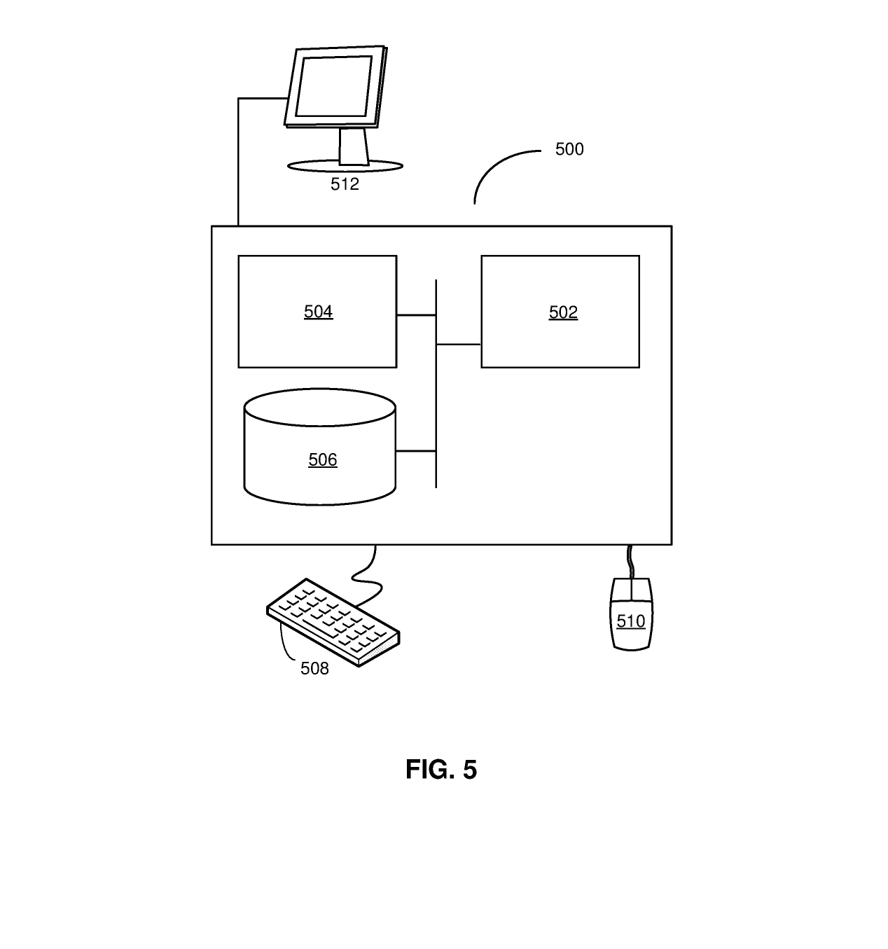

FIG. 5 shows a computer system in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for migrating traffic between versions of a distributed service. The system includes a set of nested controllers that use a set of rules to select a first deployment environment for processing a query of the distributed service. Next, the nested controllers transmit the query to the first deployment environment and/or to a second deployment environment for processing the query. The system also includes a validation system that uses a first response to the query from the first deployment environment and a second response to the query from the second deployment environment to validate the first and second versions of the distributed service.

In addition, one or more components of computer system 500 may be remotely located and connected to the other components over a network. Portions of the present embodiments (e.g., nested controllers, validation system, source environment, destination environment, dark canary environment, services, service versions, etc.) may also be located on different nodes of a distributed system that implements the embodiments. For example, the present embodiments may be implemented using a cloud computing system that monitors and/or manages the migration or replication of traffic among a set of remote services and/or environments.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
executing, on one or more computer systems, a set of nested controllers for migrating traffic from a first version of a distributed service to a second version of the distributed service;
using a set of rules to select, by the set of nested controllers, a first deployment environment for processing a query of the distributed service, wherein the set of rules comprises:
a percentage of traffic to migrate from the first distributed service to the second distributed service; and
a deployment environment for supporting a feature of the query; and
transmitting the query to the first deployment environment.

2. The method of claim 1, further comprising:
transmitting the query to a second deployment environment for processing the query of the distributed service; and
using a first response to the query from the first deployment environment and a second response to the query from the second deployment environment to validate the first and second versions of the distributed service.

3. The method of claim 2, wherein the second deployment environment comprises a dark canary environment for the distributed service.

4. The method of claim 2, wherein the first and second deployment environments comprise a source environment and a destination environment for the first and second versions.

5. The method of claim 2, wherein the set of nested controllers executes in the source environment to migrate traffic to the destination environment.

6. The method of claim 2, wherein the first and second distributed services are validated using at least one of:
an error rate;
a latency; and
a result set discrepancy between the first and second queries.

7. The method of claim 1, wherein the set of rules further comprises a control loop.

8. The method of claim 7, wherein the control loop comprises:
an error;
an error duration; and
an error rate.

9. The method of claim 1, wherein the set of rules comprises a size of the query or a response to the query.

10. The method of claim 1, wherein using the set of rules to select the first deployment environment for processing the query comprises at least one of:
using an output of a first rule as an input to a second rule; and
using the second rule to override the first rule.

11. The method of claim 1, wherein the first and second distributed services comprise a graph database.

12. An apparatus, comprising:
one or more processors; and
memory storing instructions that, when executed by the one or more processors, cause the apparatus to:
execute a set of nested controllers for migrating traffic from a first version of a distributed service to a second version of the distributed service;
use a set of rules to select, by the set of nested controllers, a first deployment environment for processing a query of the distributed service; and
transmit the query to the first deployment environment.

13. The apparatus of claim 12, wherein the memory further stores instructions that, when executed by the one or more processors, cause the apparatus to:
transmit the query to a second deployment environment for processing the query of the distributed service; and
use a first response to the query from the first deployment environment and a second response to the query from the second deployment environment to validate the first and second versions of the distributed service.

14. The apparatus of claim 13, wherein the second deployment environment comprises a dark canary environment for the distributed service.

15. The apparatus of claim 13, wherein the first and second deployment environments comprise a source environment and a destination environment for the first and second versions.

16. The apparatus of claim 12, wherein using the set of rules to select the first deployment environment for processing the query comprises at least one of:
using an output of a first rule as an input to a second rule; and
using the second rule to override the first rule.

17. The apparatus of claim 12, wherein the set of rules comprises at least one of:
a control loop;
a percentage of traffic to migrate from the first distributed service to the second distributed service; and
a deployment environment for supporting a feature of the query.

18. The apparatus of claim 17, wherein the control loop comprises:
an error;
an error duration; and
an error rate.

19. A non-transitory computer-readable storage medium storing instructions that when executed by a computer cause the computer to perform a method, the method comprising:
executing a set of nested controllers for migrating traffic from a first version of a distributed service to a second version of the distributed service;
using a set of rules to select, by the set of nested controllers, a first deployment environment for processing a query of the distributed service; and
transmitting the query to the first deployment environment.

20. The non-transitory computer-readable storage medium of claim 19, wherein the method further comprises:
transmitting the query to a second deployment environment for processing the query of the distributed service; and
using a first response to the query from the first deployment environment and a second response to the query from the second deployment environment to validate the first and second versions of the distributed service.
